(19) United States
(12) Patent Application Publication
(10) Pub. No.: US 2026/0024006 A1
(43) Pub. Date: Jan. 22, 2026

(54) Selective Information Sharing Between Different Storage Devices

(71) Applicant: Sandisk Technologies, Inc., Milpitas, CA (US)

(72) Inventors: Ariel NAVON, Revava (IL); Shay BENISTY, Beer Sheva (IL); David AVRAHAM, Even Yehuda (IL)

(73) Assignee: Sandisk Technologies, Inc., Milpitas, CA (US)

(21) Appl. No.: 18/776,061

(22) Filed: Jul. 17, 2024

(51) Int. Cl. G06N 20/00

(52) U.S. Cl. CPC G06N 20/00

(57) ABSTRACT

Data privacy and fulfilling security limitations are ensured during ML algorithm and AI model training by forcing the distinct separation of stored data of each data storage device and preventing the allowance of information sharing between other data storage devices. Specifically, a privacy-preserving information-sharing method is implemented between data storage devices in a joint system. The data of each storage device is not exposed to other storage devices in the joint system. Instead, predictive conclusions based on statistical and ML analysis derived from the collective data of all the storage devices is observed by each storage device. Thus, by allowing the sharing of data insights between storage devices without exposing the data of each storage device to other storage devices, performance and reliability of a storage device is improved.

### BACKGROUND OF THE DISCLOSURE

### Field of the Disclosure

Embodiments of the present disclosure generally relate to a data storage device with selective information sharing between other data storage devices.

### Description of the Related Art

Storage systems, such as solid state drives (SSDs) including NAND flash memory, are commonly used in electronic systems ranging from consumer products to enterprise-level computer systems. The market for SSDs has increased and its acceptance for use by private enterprises or government agencies to store data is becoming more widespread. Data storage devices may also be used in the training of machine learning (ML) algorithms and artificial intelligence (AI) models. When training ML algorithms and AI models, data from a client device (e.g., a local data storage device or an end device) may be exchanged between the client device and a central or global server. Or even, in some cases, exposed to other client devices. In other cases, data from the client device may be stored on the central or global server. Preserving the privacy and security of client device data improves the performance and reliability of the data storage devices used in such ML algorithms and AI model.

Accordingly, there is a need in the art for an improved data storage device with selective information sharing between other data storage devices.

### SUMMARY OF THE DISCLOSURE

Data privacy and fulfilling security limitations are ensured during ML algorithm and AI model training by forcing the distinct separation of stored data of each data storage device and preventing the allowance of information sharing between other data storage devices. Specifically, a privacy-preserving information-sharing method is implemented between data storage devices in a joint system. The data of each storage device is not exposed to other storage devices in the joint system. Instead, predictive conclusions based on statistical and ML analysis derived from the collective data of all the storage devices is observed by each storage device. Thus, by allowing the sharing of data insights between storage devices without exposing the data of each storage device to other storage devices, performance and reliability of a storage device is improved.

In one embodiment, a data storage device includes a memory device; and a controller coupled to the memory device, wherein the controller is configured to receive a collect data request; generate at least one parameters gradient of a predictive model of the data storage device based on data corresponding to the collect data request; share the at least one parameters gradient with a second data storage device; and update the predictive model, wherein the update to the predictive model is based on the at least one parameters gradient shared with the second data storage device.

In another embodiment, a data storage device includes a memory device; and a controller coupled to the memory device, wherein the controller is configured to: generate at least one parameters gradient based on data of the data storage device; utilize a predictive model of the data storage device to tune at least one parameter value of the data storage device based on the generated at least one parameters gradient; and share the tuned at least one parameter value with a second data storage device.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIGS. 2A-2C are illustrative diagrams of federated learning protocols for training an AI model, according to some embodiments.

FIG. 3 is a schematic illustration of a trivial centralized learning protocol, according to some embodiments.

FIG. 4 is a schematic illustration of a centralized federated learning protocol with predictive information sharing, according to some embodiments.

FIG. 5 is a flowchart illustrating a synchronized training and model distribution of a federated learning protocol, according to some embodiments.

FIG. 6 is a flowchart illustrating a non-synchronized training and synchronized model distribution of a federated learning protocol, according to some embodiments.

FIG. 7 is a flowchart illustrating a non-synchronized training and model distribution of a federated learning protocol, according to some embodiments.

FIG. 8 is a flowchart illustrating a decentralized federated learning protocol, according to some embodiments.

FIGS. 9A-9B are flowcharts illustrating a parameter tuning predictive model, according to some embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Data privacy and fulfilling security limitations are ensured during ML algorithm and AI model training by forcing the distinct separation of stored data of each data storage device and preventing the allowance of information sharing between other data storage devices. Specifically, a privacy-preserving information-sharing method is implemented between data storage devices in a joint system. The data of each storage device is not exposed to other storage devices in the joint system. Instead, predictive conclusions based on statistical and ML analysis derived from the collective data of all the storage devices is observed by each storage device. Thus, by allowing the sharing of data insights between storage devices without exposing the data of each storage device to other storage devices, performance and reliability of a storage device is improved.

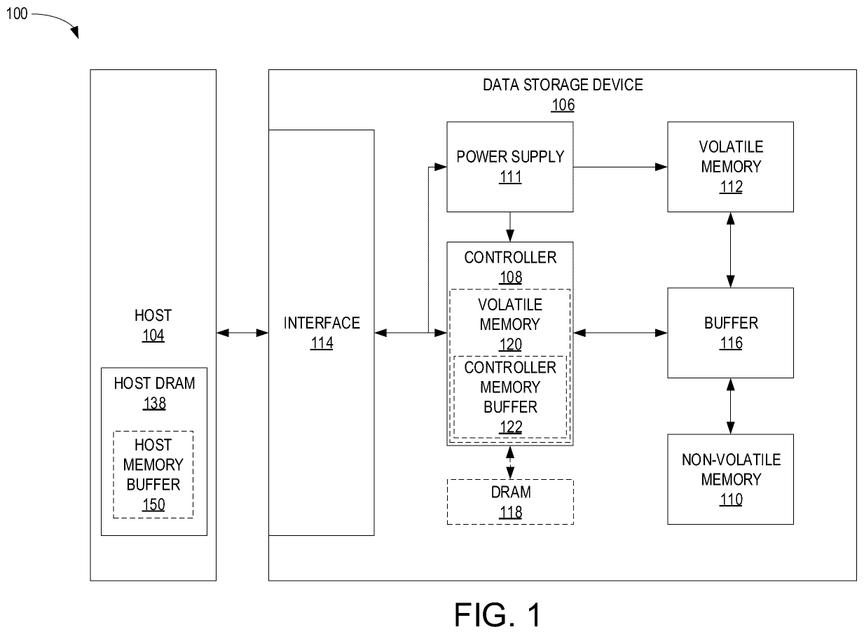

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVMe Flash memory devices may include NAND or NOR-based flash memory devices and may store data based on a charge contained in a floating gate of a transistor for each flash memory cell. In NVMe flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVMe cells. Rows of NVMe cells may be electrically connected using a word line to define a page of a plurality of pages. Respective cells in each of the plurality of pages may be electrically connected to respective bit lines. Furthermore, NVMe flash memory devices may be 2D or 3D devices and may be single level cell (SLC), multi-level cell (MLC), triple level cell (TLC), or quad level cell (QLC). The controller 108 may write data to and read data from NVMe flash memory devices at the page level and erase data from NVMe flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

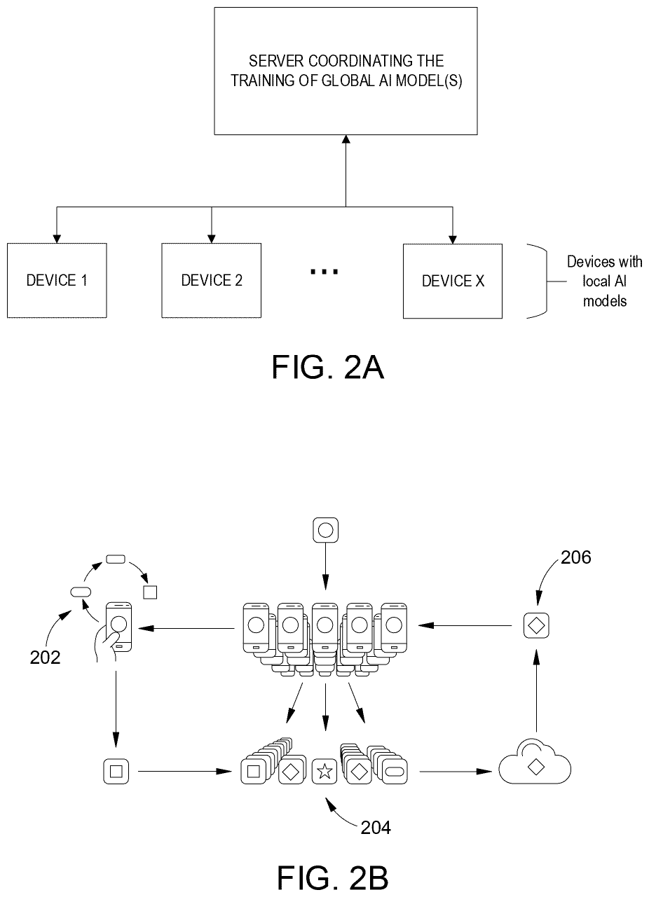

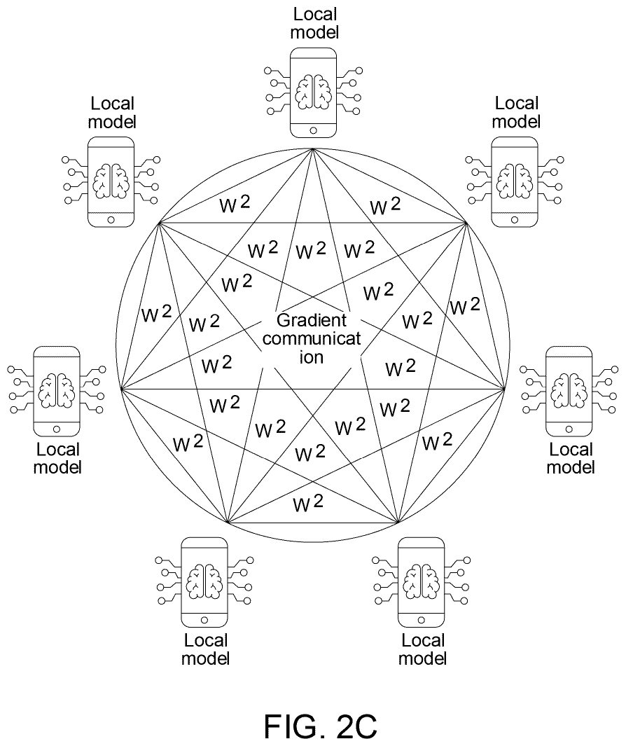

FIGS. 2A-2C are illustrative diagrams of federated learning protocols for training an AI model, according to some embodiments. For example, as shown in FIG. 2A, federated learning (often referred to as collaborative learning) is an approach to training machine learning models. That is, it does not require an exchange of client device data to global servers. Instead, the raw data on local devices with local AI models (such as Device 1, 2, and 3 in FIG. 2A) is used to train the model locally, increasing data privacy. Conceptually, federated learning allows secure collaboration between different end-users (such as Device 1, 2, and 3 in FIG. 2A). Federated learning enables preserving privacy and security, since the original private data of each of the local devices is not exposed, but rather only relevant encrypted-like local model parameters are shared. Thus, federated learning enables optimized performance when data sharing between different storage devices, all the while preserving data privacy and security requirements.

The performance of data storage devices is crucial because it affects not only the reliability but also the cost of the storage devices. Previous efforts to optimize device performance in statistical analysis and ML prediction models include tuning the background operations to low traffic timings at the pipeline (per workload). However, all these previous efforts are restricted to utilizing statistics/prediction models that are based on the data captured in a specific storage device (due to privacy regulations and security restrictions). Other efforts propose data sharing between a local storage device and a central server, which may improve performance optimization based on a large number of devices but are limited in use due to being reliant on special permission access and/or non-private data of the storage device.

Therefore, there is a need to allow utilization of relevant information extracted from a collective of storage devices, while still validating the preservation of data privacy and avoiding the exposure of specific data outside of each device. By allowing the sharing of data insights between storage devices without exposing the data of each storage device to other storage devices, performance and reliability of a storage device may be improved.

As shown in FIG. 2B, in some embodiments, a centralized federated learning approach may be implemented in which one moderator (e.g., central node or central server) concentrates the accumulation of weights updated by each device based on a local calculation of the parameters gradients (“gradient”) of the local data stored at each device. For example, at operation 202, a local device downloads the current model. The model is then improved by personalizing the AI model locally based on usage, and changed as a small focused update. At operation 204, only this small focused update to the model is sent to the cloud using encrypted communication, where, at operation 206, it is immediately averaged with other user updates to improve the shared mode, after which the procedure is repeated. Accordingly, all the training data remains on the local device, and no individual updates are stored in the cloud or central server/node.

As shown in FIG. 2C, in some embodiments, a decentralized federated learning approach may be implemented in which there is a direct handshake between the different storage devices, without a centralized moderator.

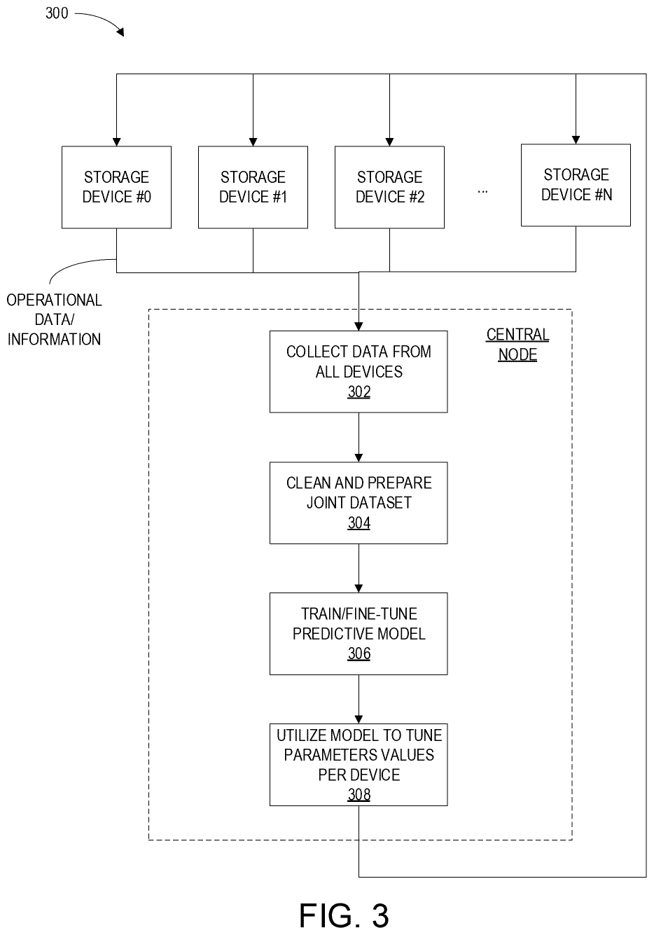

FIG. 3 is a schematic illustration of a trivial centralized learning protocol 300, according to some embodiments. In the trivial centralized learning protocol 300, several storage devices are communicatively coupled to a central node (e.g., a central server or moderator). Operational data or information of each of the storage devices are provided to the central node. At operation 302, the central node collects the operational data or information from the storage devices. At operation 304, the central node cleans the collective operational data or information of the storage devices and prepares a joint dataset from the collective operational data. At operation 306, the central node updates the global predictive model by training and fine-tuning the global predictive model based on the joint dataset from the collective operation data. At optional operation 308, the central node utilizes the predictive model to tune parameter values per storage device. In some embodiments, at optional operation 308, the central node sends the updated parameters/thresholds of the trained and tuned global predictive model back to the storage devices, for the storage devices' own use in a local model. For example, these parameters/thresholds can be tuned by each storage device based on some reported indication, such as P/E counter value, typical workloads, etc. In certain embodiments, the local model of each storage device is tuned jointly to all local storage devices. It should be noted that, generally, the output of the global predictive model of the central node (e.g., parameter values) may be used for sending the tuned predictive model (e.g., a tuned model based on the inputs accumulated from all storage devices)—or a portion of it—back to the storage devices, or sending general information provided by applying the local model at the central node back to the storage devices (e.g., updated operational parameters, such as values of programming-steps, voltage-windows-weights, etc.). After tuning the operational parameter values, the storage devices may be updated with the tuned operational parameters.

In some embodiments, predictive models that are targeted to optimize storage management may include one or more of the following types: identifying expected idle-times in the management pipeline and schedule maintenance background operations during these idle times (including execution of garbage-collection, best estimate scan (BES) read thresholds updates, data relocations, and single-level cell (SLC) to quad-level cell (QLC) folding, etc.); prediction of device end-of-life (EOL) (e.g., based on predefined performance degradation); prediction of decoding gear to use (e.g., predict failure rates at low-decoding gears-ultra linear programming (ULP)/linear programming (LP)); and prediction of block relocation thresholds according to program/erase cycle (PEC) count and bit error rate (BER) distributions. In some embodiments, relevant parameters or features that could be concluded from each device and be used as inputs to these predictive models include, for example: command sizes (average, median, standard deviation (STD), max, etc.—at different past windows); command length; commands type (e.g., read, write, or flush); operational languages; typical queues—length; typical BER/fail bit count (FBC)/syndrome weight values); workload types (e.g., random or sequential); number of operated threads; power consumption (e.g., peak and average); number of W/E cycles; number of reads per die/block/WL (e.g., max and average); duration of typical internal commands (e.g., encoding and decoding); ASIC internal sensors records; etc.

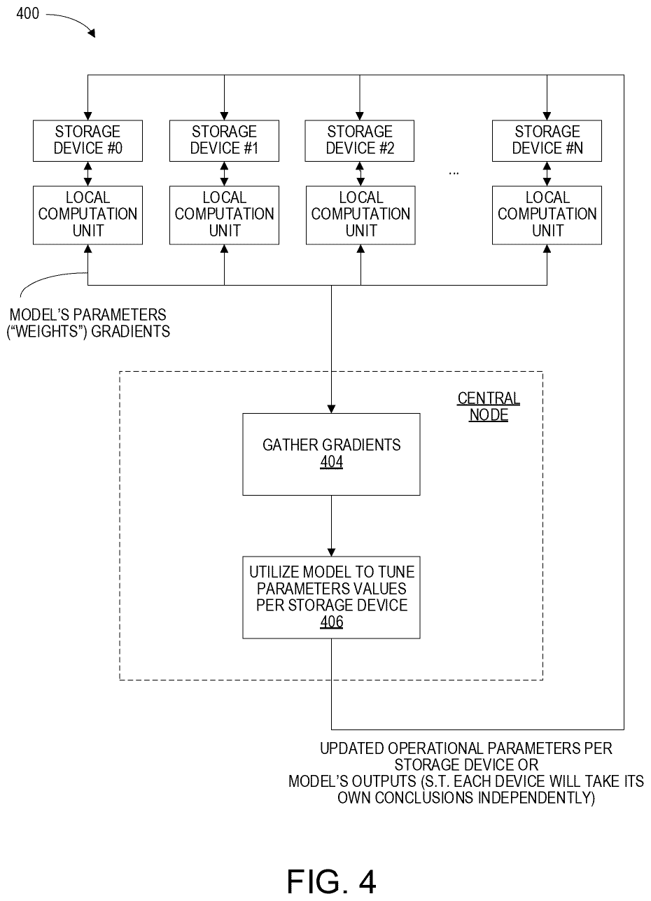

FIG. 4 is a schematic illustration of a centralized federated learning protocol 400 with predictive information sharing, according to some embodiments. In the centralized federated learning protocol 400 with predictive information sharing, several storage devices with local commutation units (e.g., Storage Devices 0, 1, 2, N of FIG. 4) are communicatively coupled to a central node (e.g., a central server or moderator). In federated learning approaches, a predictive model is trained or fine-tuned based on the data stored at all devices, without transferring or exposing the data itself to any other storage device. Specifically, in a centralized federated learning protocol 400, the training of the predictive model is mostly done at the local storage device (such as storage device 0, 1, 2, and N of FIG. 4), whereas the gathering of the weights-gradients is done at the centralized server (e.g., central node or moderator). That is, a central node (e.g., moderator or central server) concentrates an accumulation of weights updated on each storage device in accordance with local calculations of the gradients based on the local data stored at each storage device.

Each of the local storage devices comprises a local computation unit that locally conducts calculations including receiving the collected local data then cleaning and preparing a dataset with the collected local data of the storage device. In some embodiments, based on the local calculations, the local storage device may further determine and provide a parameter tuning recommendation to the central node. At operation 404, the central node gathers each local model's parameters (“weights”) gradients. At operation 406, the central node utilizes the predictive model to tune parameter values per local storage device. In some embodiments, the operational parameters are updated per local storage device. In some embodiments, the operational parameters are updated per the predictive model's outputs (e.g., each storage device will take its own conclusions independently). In some embodiments, tuning parameter values of the predictive model comprises comparing real values versus predicted values generated by the predictive model and adjusting the parameters based on the differences between the real values and the predicted values. After tuning the operational parameter values, the storage devices may be updated with the tuned operational parameters—e.g., updating the local model of the storage device to match the tuned operational parameters.

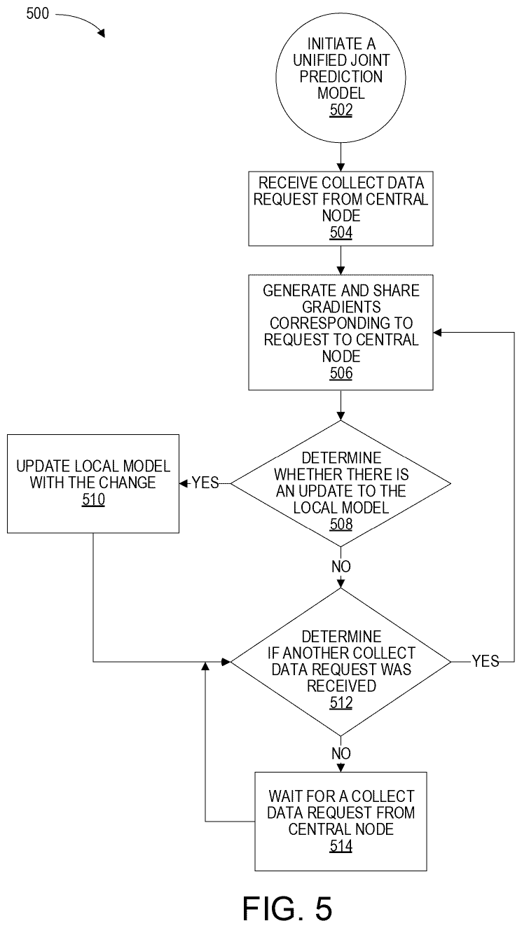

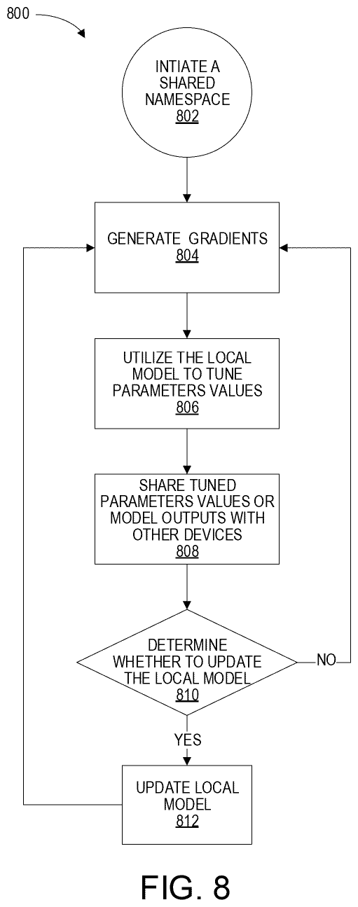

Certain joint system embodiments—e.g., a centralized federated learning protocol)—may include many storage devices creating a large distributed system, which are described in further detail below in FIGS. 5, 6, and 7, as well as, a decentralized federated learning protocol in FIG. 8. In these joint system embodiments, a privacy-preserving information-sharing method may be implemented between storage devices. As a result, the data of each of the storage devices cannot be observed by other devices, but the storage devices will still be exposed to predictive conclusions which are based on statistical and ML analysis—which are built from the collective data of all the storage devices. In this way, a method to improve storage device performance and reliability by allowing the sharing of data insights between storage devices without exposing the data itself is disclosed. Accordingly, federated learning permits the building of a predictive ML model based on the joint data of all the storage devices in the joint system while preserving data privacy of each storage device; thereby, enabling the preservation of data privacy and prevention of security violations.

FIG. 5 is a flowchart illustrating a synchronized training and model distribution 500 of a centralized federated learning protocol, according to some embodiments. Synchronized training and model distribution 500 may be an implementation of a centralized federated learning protocol in a joint system, such as the centralized federated learning protocol 400 of FIG. 4.

Synchronized training and model distribution 500 begins at operation 502, where a unified joint prediction model is initiated in the joint system. At operation 504, a storage device receives a collect data request from the central node. At operation 506, the storage device generates a locally calculated gradient based on local data stored on the storage device that corresponds to the collect data request and shares the gradient with the central node. The central node may request data from all local storage devices at the same time (e.g., simultaneously) or in a periodical manner (e.g., gradually) by directly managing them according to their workloads, or even by creating idle times in which the central node accesses the data from the storage devices and trains the local model. After receiving gradients from the storage devices, the central node (e.g., moderator) is responsible for generating a unified predictive model that embeds the data from all the local storage devices (e.g., local nodes) and directly manages all other local storage devices. Accordingly, the central node may decide when and how to update the storage devices, and timing the update times according to the needs of the joint system.

At operation 508, the storage device determines whether there is an update to the local model by checking whether the central node has updated the unified predictive model. If there is an update to the unified predictive model, at operation 510, the storage device updates the local model with the corresponding changes as the updated unified predictive model and then proceeds to operation 512. If there is no update to the local model (e.g., the unified predictive model was not updated or changed), then at operation 512, the storage device determines if another or subsequent collect data request was received from the central node. If no subsequent collect data request was received, then at operation 514, the storage device waits for another collect data request from the central node before returning to operation 506 when the storage device determines that another collect data request is received. In some embodiments, the sharing of the gradient with the central node and updating of the local model (i.e., operation 506 and operation 510) may occur at the same time (e.g., simultaneously) or in a periodical manner (e.g., gradually).

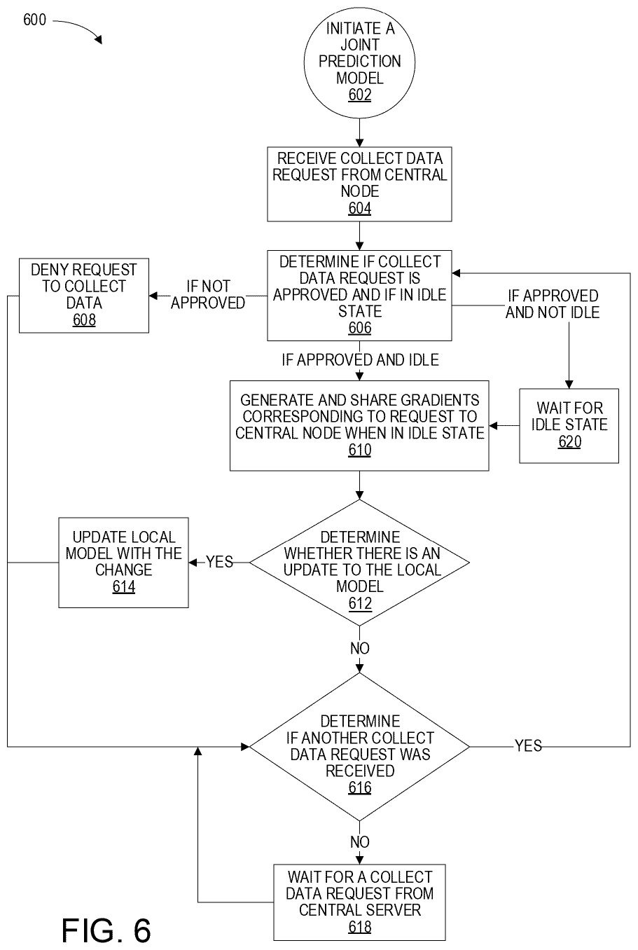

FIG. 6 is a flowchart illustrating a non-synchronized training and synchronized model distribution 600 of a centralized federated learning protocol, according to some embodiments. Non-synchronized training and synchronized model distribution 600 may be an implementation of a centralized federated learning protocol in a joint system, such as the centralized federated learning protocol 400 of FIG. 4. In some embodiments, a distributed large system may entail a central node held by a large company and storage devices (e.g., end devices) that are privately held. For example, all the cell phones of a certain vendor where each cell phone may have local storage. In some embodiments, the central node does not have control over the storage devices' local storage and may gather and spread data if approved by the storage device's settings.

In certain embodiments, the distributed large system (e.g., the joint system) will not be able to schedule times to collect data from the storage devices and train the local model of each storage device, and will therefore have to work opportunistically in the background during an idle time of the storage device. The local model of the storage device will be sent to the central node a-synchronously, i.e., whenever the storage device is available. At that time, the updated predictive model aggregated by all the local models learned in the distributed system will be applied synchronically by a system update (e.g., regular phone updates or specifically NAND Field Firmware Updates (FFUs)). Thus, the storage device will share the local model and receive an updated model at the same time. Whereas, the central node will collect all of the local models from the storage devices incrementally and will publish the updated predictive models that will be put to use by the local models according to each storage devices' abilities and availability.

Non-synchronized training and synchronized model distribution 600 begins at operation 602, where a joint prediction model is initiated in the joint system. At operation 604, a storage device receives a collect data request from the central node. At operation 606, the storage device determines if the collect data request is approved and if the storage device is in an idle state. If the collect data request is approved by the storage device settings but the storage device is not in an idle state, then at operation 620, the storage device waits until an idle state is reached before proceeding to operation 610. In some embodiments, approval of the collect data request is determined by the storage device settings which is based on whether the central node has control over the storage device. In some embodiments, approval of the collect data request may also be determined based on whether the storage device detects a potential security threat. However, if the collect data request is not approved, then at operation 608, the storage device denies the collect data request and proceed to operation 616. If the collect data request is approved and the storage device is in an idle state, then at operation 610, the storage device generates a locally calculated gradient based on local data stored on the storage device that corresponds to the collect data request and shares the gradient with the central node.

At operation 612, the storage device determines whether there is an update to the local model by checking whether the central node has updated the predictive model. If there is an update to the predictive model, at operation 614, the storage device updates the local model with the corresponding changes as the updated predictive model and then proceeds to operation 616. If there is no update to the local model (e.g., the predictive model was not updated or changed), then at operation 616, the storage device determines if another or subsequent collect data request was received from the central node. If no subsequent collect data request was received, then at operation 618, the storage device waits for another collect data request from the central node and returns to operation 606 when a collect data request is received. In some embodiments, the sharing of the gradient with the central node and the updating of the local model (i.e., operation 610 and operation 614) may occur at the same time (e.g., simultaneously) or in a periodical manner (e.g., gradually).

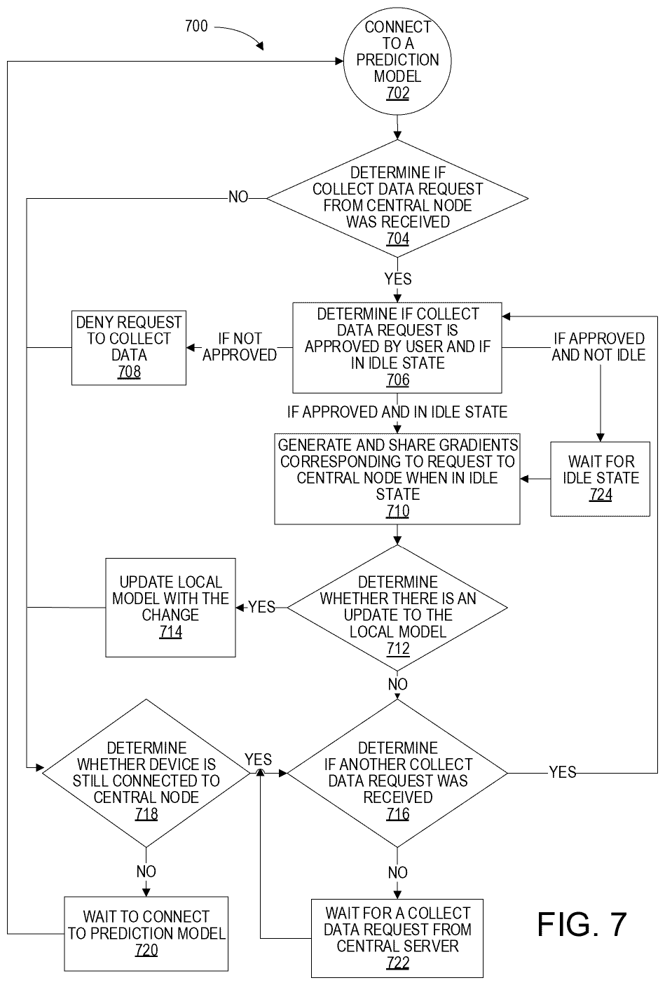

FIG. 7 is a flowchart illustrating a non-synchronized training and model distribution 700 of a federated learning protocol, according to some embodiments. Non-synchronized training and model distribution 700 may be an implementation of a centralized federated learning protocol in a joint system, such as the centralized federated learning protocol 400 of FIG. 4. In some embodiments, a joint system may comprise storage devices that are not interconnected regularly and may have given periods where they may be able to share the local models and get an updated model trained by the central node. These circumstances may be the case when the joint system comprises storage devices that are not directly connected to the outer world, including for example: offline devices, IoT devices, or devices that are regularly connected to the network but don't have the required privileges to use the network. Additionally, these joint systems, and in particular their storage, may have access to the world only when the firmware is updated, which is determined by the storage device settings. Thus, the storage device may share the local model and get an updated model at the same time. The central node will collect all the data from the storage devices incrementally and will publish new models that will be implemented by the storage devices according to each storage devices' abilities and availability.

Non-synchronized training and model distribution 700 begins at operation 702, where the controller of a storage device connects to a prediction model. At operation 704, a storage device determines if a collect data request has been received from the central node. If a collect data request has not been received by the storage device, then at operation 718, the controller determines whether the storage device is still connected to the central node. If the storage device is not connected to the central node, then at operation 720, the storage device waits for the connection to the central node to be re-established before returning to operation 702. If the storage device is still connected to the central node, then at operation 716, the storage device further determines if another or subsequent collect data request was received from the central node. If a collect data request has been received by the storage device, then at operation 706, the storage device determines if the collect data request is approved and if the storage device is in an idle state.

If the collect data request is approved by the storage device settings but the storage device is not in an idle state, then at operation 724, the storage device waits until an idle state is reached before proceeding to operation 710. However, if the collect data request is not approved, then at operation 708, the storage device denies the collect data request and proceeds to operation 718. In some embodiments, approval of the collect data request is determined by the storage device settings which is based on whether the central node has control over the storage device. If the collect data request is approved and the storage device is in an idle state, then at operation 710, the storage device generates a locally calculated gradient based on local data stored on the storage device that corresponds to the collect data request and shares the gradient with the central node.

At operation 712, the storage device determines whether there is an update to the local model by checking whether the central node has updated the predictive model. If there is an update to the predictive model, at operation 714, the storage device updates the local model with the corresponding changes as the updated predictive model and then proceeds to operation 718. If there is no update to the local model (e.g., the predictive model was not updated or changed), then at operation 716, the storage device determines if another or subsequent collect data request was received from the central node. If no subsequent collect data request was received, then at operation 722, the storage device waits for another collect data request from the central node and returns to operation 706 when a collect data request is received. In some embodiments, the sharing of the gradient with the central node and the updating of the local model (i.e., operation 710 and operation 714) may occur at the same time (e.g., simultaneously) or in a periodical manner (e.g., gradually).

In some embodiments, a gradual training schedule may be implemented in order to accelerate the execution of a federated learning protocol (such as centralized federated learning protocols FIGS. 5, 6 and 7), including in federated learning protocols which may be executed during idle times of the storage devices (such as federated learning protocols of FIGS. 6 and 7). During a gradual training schedule, the storage device may receive requests from the central node to update the storage device's contribution to the joint prediction model in a serial manner relative to the other storage devices. In turn, the storage device may receive the updated results with the other storage devices when the central node shares the updated results, even before the execution or completion of the training of these storage devices.

FIG. 8 is a flowchart illustrating a decentralized federated learning protocol 800, according to some embodiments. A joint system implementing a decentralized federated learning protocol 800 comprises a shared namespace where each storage device reports its results and other storage devices will have read access to it. Decentralized federated learning protocol 800 begins at operation 802, where the joint system initiates a shared namespace. At operation 804, each storage device of the joint system generates a locally calculated gradient based on local data stored on the storage device. At operation 806, the storage device utilizes the local model of the storage device to tune parameters values of the local model. In some embodiments, tuning parameter values of the local model comprises comparing real values of the local model versus predicted values generated by the local model and adjusting the parameters of the local model based on the differences between the real values and the predicted values. At operation 808, the storage device optionally shares recommendations based on the tuned parameters values or local model outputs with other storage devices in the shared namespace.

At operation 810, the storage device determines whether to update the local model. In some embodiments, the determination whether to update the local model is based on the storage device's evaluation of the published tuned parameters, or recommendations, from other storage devices. If the storage device determines to update the local model, then at operation 812, the storage device updates the local model based on published results (e.g., tuned parameters or local model outputs) from other storage devices, and then returns to operation 804. If the storage device determines not to update the local model, then the storage device returns to operation 804. In some embodiments, the sharing of the tuned parameter values or model outputs and the updating of the local model (i.e., operation 808 and operation 810) may occur at the same time (e.g., simultaneously) or in a periodical manner (e.g., gradually).

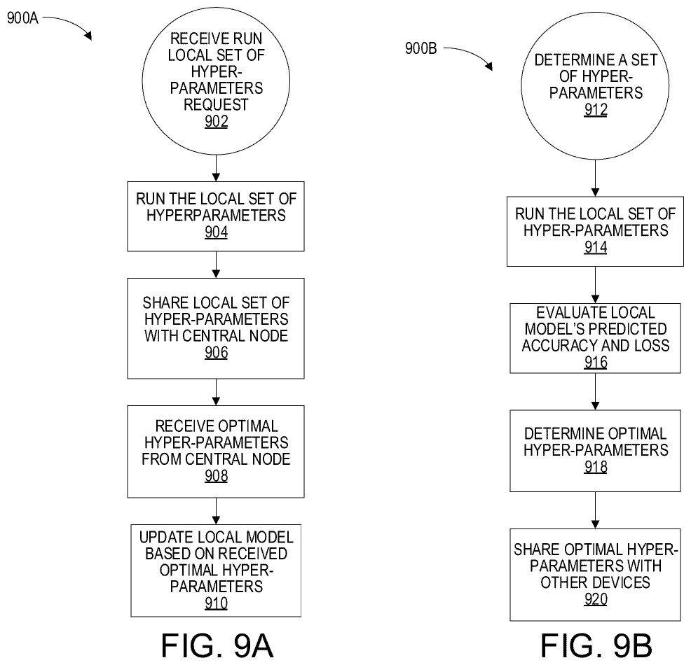

FIGS. 9A-9B are flowcharts illustrating parameter tuning predictive models 900A and 900B, according to some embodiments. In some embodiments, hyper-parameters are selected according to greater wisdom of the federated system. Thus, hyper-parameters may be specific parameters that are targeted for saving time and getting more accurate predictive models. In some embodiments, e.g. in centralized federated learning protocols, the central node (e.g., moderator or central server) searches for the best hyper-parameters and publishes them. In some embodiments, each storage device may run a local set of hyper-parameters either by a simple local grid search, auto-tuning, or by randomly selecting from a known range of previously trained parameters (e.g., generating some explorations of the parameters space). The selected parameters may be shared with the central node and, if possible, the predictive model's predicted accuracy or loss. Both the predicted accuracy and loss will be used by the central node to select the optimal hyper-parameters from the selected parameters.

In some embodiments, a storage device is configured to use a set of local parameters. This would benefit certain embodiments, where certain storage devices experience unique data that call for specific parameters. Or other embodiments, where the central node does not directly control the joint system and may only learn from it and publish common data.

As shown in FIG. 9A, in some embodiments, a parameter tuning predictive model 900A may be implemented in a centralized federated learning protocol (e.g., centralized federated learning protocols of FIGS. 5, 6, and 7). At operation 902, the storage device receives a run local set of hyper-parameters request from the central node. At operation 904, the storage device runs the local set of hyper-parameters corresponding to the received request. At operation 906, the storage device shares the local set of hyper-parameters with the central node. At operation 908, the storage device receives from the central node the identified optimal hyper-parameters. At operation 910, the storage device updates the local model based on the received optimal hyper-parameters.

As shown in FIG. 9B, in some embodiments, a parameter tuning predictive model 900B may be implemented in a decentralized federated learning protocol (e.g., decentralized federated learning protocol 800 of FIG. 8). At operation 912, the storage device determines a set of hyper-parameters. At operation 914, the storage device runs the local set of hyper-parameters. At operation 916, the storage device evaluates the local model's predicted accuracy and loss based on the set of hyper-parameters. At operation 918, the storage device determines the optimal hyper-parameters based on the evaluated predicted accuracy and loss of the local model. At operation 920, the storage device shares the optimal hyper-parameters with other storage devices in the joint system.

Thus, data privacy and fulfilling security limitations are ensured during ML algorithm and AI model training by forcing the distinct separation of stored data of each data storage device and preventing the allowance of information sharing between other data storage devices. Specifically, a privacy-preserving information-sharing method is implemented between data storage devices in a joint system. The data of each storage device is not exposed to other storage devices in the joint system. Instead, predictive conclusions based on statistical and ML analysis derived from the collective data of all the storage devices is observed by each storage device. Thus, by allowing the sharing of data insights between storage devices without exposing the data of each storage device to other storage devices, performance and reliability of a storage device is improved.

In one embodiment, a data storage device includes a memory device; and a controller coupled to the memory device, wherein the controller is configured to receive a collect data request; generate at least one parameters gradient of a predictive model of the data storage device based on data corresponding to the collect data request; share the at least one parameters gradient with a second data storage device; and update the predictive model, wherein the update to the predictive model is based on the at least one parameters gradient shared with the second data storage device.

The data corresponding to the collect data request is not exposed to the second data storage device. The second data storage device is a central node, and wherein the central node is communicatively coupled to a plurality of data storage devices. The data corresponding to the collect data request is not exposed to the plurality of data storage devices. The update to the predictive model is based on a plurality of parameters gradients shared with the central node, and wherein the plurality of parameters gradients is generated from the plurality of data storage devices. The sharing and updating are simultaneous. The sharing and updating are periodic. The controller is further configured to determine if the collect data request is approved, and wherein the approval is based on whether the second data storage device has control over the data storage device. The generation of the at least one parameters gradient corresponding to the collect data request is based on the determination that the collect data request is approved. The controller is further configured to determine if the data storage device is in an idle state, and determine if the data storage device is communicatively coupled to the second data storage device. The generation of the at least one parameters gradient corresponding to the collect data request is based on whether the data storage device is in an idle state. The predictive model of the data storage device is part of a synchronized training and model distribution. The predictive model of the data storage device is part of a non-synchronized training and model distribution.

In another embodiment, a data storage device includes a memory device; and a controller coupled to the memory device, wherein the controller is configured to: generate at least one parameters gradient based on data of the data storage device; utilize a predictive model of the data storage device to tune at least one parameter value of the data storage device based on the generated at least one parameters gradient; and share the tuned at least one parameter value with a second data storage device.

The controller is further configured to share an output of the predictive model of the data storage device with the second data storage device. The controller is further configured to recommend a change to a predictive model of the second data storage device. The controller is further configured to update the predictive model of the data storage device based on a recommendation from the second data storage device. The at least one parameters gradient of the data storage device is not exposed to the second data storage device.

In yet another embodiment, a data storage device includes means to store data; and a controller coupled to the means to store data, wherein the controller is configured to determine a set of hyper-parameters; run the set of hyper-parameters; and evaluate a statistic from the set of ran hyper-parameters via a predictive model of the data storage device, wherein the data storage device is a first data storage device of a plurality of data storage devices and the plurality of data storage devices are communicatively coupled to read-access the statistic.

The controller is further configured to share the statistic with a second data storage device of the plurality of data storage devices, wherein the statistic is an accuracy of a predictive value versus a real value of the set of ran hyper-parameters; receive at least one hyper-parameter's value from the second data storage device based on the shared statistic; update the predictive model of the data storage device based on the at least one received hyper-parameter's value; determine a change to the predictive model based on the statistic; and recommend the change to a predictive model of the second data storage device.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
receive a collect data request;
generate at least one parameters gradient of a predictive model of the data storage device based on data corresponding to the collect data request;
share the at least one parameters gradient with a second data storage device; and
update the predictive model, wherein the update to the predictive model is based on the at least one parameters gradient shared with the second data storage device.

2. The data storage device of claim 1, wherein the data corresponding to the collect data request is not exposed to the second data storage device.

3. The data storage device of claim 1, wherein the second data storage device is a central node, and wherein the central node is communicatively coupled to a plurality of data storage devices.

4. The data storage device of claim 3, wherein the data corresponding to the collect data request is not exposed to the plurality of data storage devices.

5. The data storage device of claim 4, wherein the update to the predictive model is based on a plurality of parameters gradients shared with the central node, and wherein the plurality of parameters gradients is generated from the plurality of data storage devices.

6. The data storage device of claim 1, wherein the sharing and updating are simultaneous.

7. The data storage device of claim 1, wherein the sharing and updating are periodic.

8. The data storage device of claim 1, wherein the controller is further configured to determine if the collect data request is approved, and wherein the approval is based on whether the second data storage device has control over the data storage device.

9. The data storage device of claim 8, wherein the generation of the at least one parameters gradient corresponding to the collect data request is based on the determination that the collect data request is approved.

10. The data storage device of claim 1, wherein the controller is further configured to:
determine if the data storage device is in an idle state; and
determine if the data storage device is communicatively coupled to the second data storage device.

11. The data storage device of claim 10, wherein the generation of the at least one parameters gradient corresponding to the collect data request is based on whether the data storage device is in an idle state.

12. The data storage device of claim 1, wherein the predictive model of the data storage device is part of a synchronized training and model distribution.

13. The data storage device of claim 1, wherein the predictive model of the data storage device is part of a non-synchronized training and model distribution.

14. A data storage device, comprising:
a memory device; and
a controller coupled to the memory device, wherein the controller is configured to:
generate at least one parameters gradient based on data of the data storage device;
utilize a predictive model of the data storage device to tune at least one parameter value of the data storage device based on the generated at least one parameters gradient; and
share the tuned at least one parameter value with a second data storage device.

15. The data storage device of claim 14, wherein the controller is further configured to share an output of the predictive model of the data storage device with the second data storage device.

16. The data storage device of claim 14, wherein the controller is further configured to recommend a change to a predictive model of the second data storage device.

17. The data storage device of claim 14, wherein the controller is further configured to update the predictive model of the data storage device based on a recommendation from the second data storage device.

18. The data storage device of claim 14, wherein the at least one parameters gradient of the data storage device is not exposed to the second data storage device.

19. A data storage device, comprising:
means to store data; and
a controller coupled to the means to store data, wherein the controller is configured to:
determine a set of hyper-parameters;
run the set of hyper-parameters; and
evaluate a statistic from the set of ran hyper-parameters via a predictive model of the data storage device, wherein the data storage device is a first data storage device of a plurality of data storage devices and the plurality of data storage devices are communicatively coupled to read-access the statistic.

20. The data storage device of claim 19, wherein the controller is further configured to:
share the statistic with a second data storage device of the plurality of data storage devices, wherein the statistic is an accuracy of a predictive value versus a real value of the set of ran hyper-parameters;
receive at least one hyper-parameter's value from the second data storage device based on the shared statistic;
update the predictive model of the data storage device based on the at least one received hyper-parameter's value;
determine a change to the predictive model based on the statistic; and
recommend the change to a predictive model of the second data storage device.
